(19) United States
(12) Patent Application Publication
(10) Pub. No.: US 2025/0054946 A1
(43) Pub. Date: Feb. 13, 2025

(54) POSITIVE ELECTRODE FOR SECONDARY BATTERIES, AND SECONDARY BATTERY

(71) Applicant: Panasonic Energy Co., Ltd., Moriguchi-shi, Osaka (JP)

(72) Inventor: Sho Urata, Hyogo (JP)

(73) Assignee: Panasonic Energy Co., Ltd., Moriguchi-shi, Osaka (JP)

(21) Appl. No.: 18/719,432

(22) PCT Filed: Dec. 19, 2022
(86) PCT No.: PCT/JP2022/046745

§ 371 Date: Jun. 13, 2024

(30) Foreign Application Priority Data
Dec. 21, 2021 (JP) 2021-206661

(51) Int. Cl. H01M 4/36; H01M 4/02; H01M 4/583

(52) U.S. Cl. CPC H01M 4/364; H01M 4/583; H01M 2004/021; H01M 2004/028

(57) ABSTRACT

A positive electrode for secondary is provided with a positive electrode mixture layer, and is characterized in that: the positive electrode mixture layer contains a positive electrode active material A which is composed of single crystalline particles of a lithium-containing composite oxide and a positive electrode active material B which is composed of polycrystalline particles of a lithium-containing composite oxide; the positive electrode active material A has a carbonaceous coating film that covers the surface of each of the single crystalline particles; the coating amount of the carbonaceous coating film covering the surfaces of the single crystalline particles is 1% by mass to 10% by mass relative to the mass of the lithium-containing composite oxide of the single crystalline particles; and with respect to the positive electrode active material B, the surfaces of the polycrystalline particles are not covered by a carbonaceous coating film.

### TECHNICAL FIELD

The present disclosure relates to a positive electrode for secondary batteries and a secondary battery.

### BACKGROUND

As a positive electrode active material for secondary batteries such as a lithium ion secondary battery, for example, Patent Literatures 1 to 3 disclose the use of a positive electrode active material containing single crystalline particles and polycrystalline particles in order to improve battery performance. In addition, Patent Literatures 4 and 5 disclose a technique in which surfaces of particles of a positive electrode active material are covered by carbon.

### CITATION LIST

### Patent Literatures

Patent Literature 1: JP 07-037576 A
Patent Literature 2: JP 2018-045998 A
Patent Literature 3: JP 2020-053386 A
Patent Literature 4: JP 11-283623 A
Patent Literature 5: JP 2203-229127 A

### SUMMARY

At the time of producing a positive electrode, a positive electrode is compressed in order to increase the density of a positive electrode mixture layer containing a positive electrode active material. However, the use of a positive electrode active material containing single crystalline particles and polycrystalline particles may result in cracking of the polycrystalline particles during the compression. Upon cracking of the polycrystalline particles, the performance of the positive electrode active material is deteriorated, and the charge-discharge cycle characteristics are remarkably deteriorated.

Therefore, an object of the present disclosure is to provide a positive electrode for secondary batteries and a secondary battery, which are capable of suppressing deterioration in charge-discharge cycle characteristics of the secondary battery even when a positive electrode active material containing single crystalline particles and polycrystalline particles is used.

A positive electrode for secondary batteries according to one embodiment of the present disclosure is provided with a positive electrode current collector and a positive electrode mixture layer that is arranged on the positive electrode current collector, and is characterized in that: the positive electrode mixture layer contains a positive electrode active material A which is composed of single crystalline particles of a lithium-containing composite oxide and a positive electrode active material B which is composed of polycrystalline particles of a lithium-containing composite oxide; the positive electrode active material A has a carbonaceous coating film that covers the surface of each of the single crystalline particles; the coating amount of the carbonaceous coating film covering the surfaces of the single crystalline particles is greater than or equal to 1% by mass and less than or equal to 10% by mass relative to the mass of the lithium-containing composite oxide of the single crystalline particles; and with respect to the positive electrode active material B, when the surfaces of the polycrystalline particles are covered by a carbonaceous coating film, the coating amount of the carbonaceous coating film covering the surfaces of the polycrystalline particles is smaller than the coating amount of the carbonaceous coating film covering the surfaces of the single crystalline particles.

A secondary battery according to an aspect of the present disclosure includes the positive electrode for secondary batteries.

According to the present disclosure, the positive electrode for secondary batteries and the secondary battery are capable of suppressing deterioration in charge-discharge cycle characteristics of the secondary battery even when a positive electrode active material containing single crystalline particles and polycrystalline particles is used.

### BRIEF DESCRIPTION OF DRAWINGS

FIG. 1 is a schematic cross-sectional view of a secondary battery as an example of an embodiment.

### DESCRIPTION OF EMBODIMENTS

Hereinafter, an example of a secondary battery according to an aspect of the present disclosure will be described.

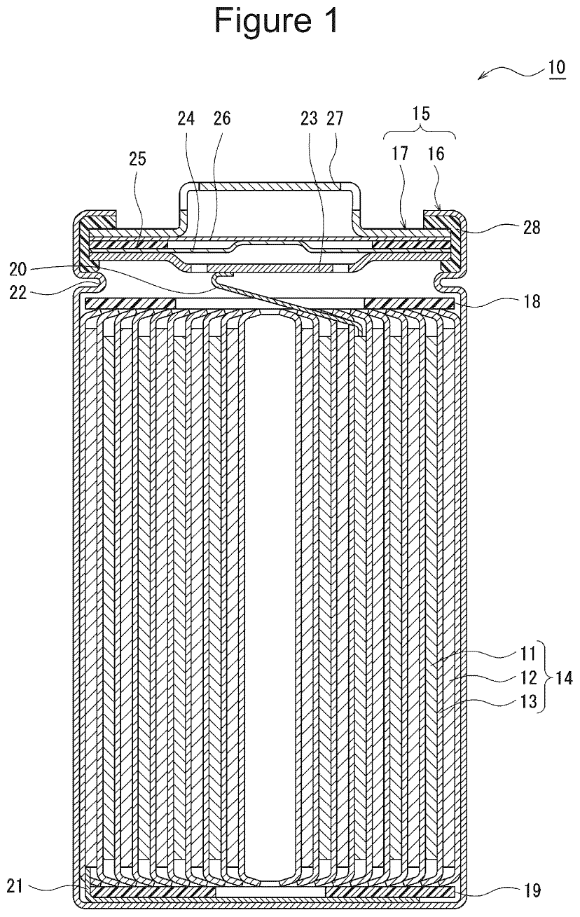

FIG. 1 is a schematic cross-sectional view of a secondary battery as an example of an embodiment. An electrolyte secondary battery 10 shown in FIG. 1 includes a wound electrode assembly 14 formed by winding a positive electrode 11 and a negative electrode 12 with a separator 13 interposed therebetween, an electrolyte, insulating plates 18 and 19 respectively disposed above and below the electrode assembly 14, and a battery case 15 housing the above-described members. The battery case 15 includes a bottomed cylindrical case body 16 and a sealing assembly 17 that closes a case body 16 opening. Instead of the wound electrode assembly 14, an electrode assembly having another form, such as a stacked electrode assembly in which positive electrodes and negative electrodes are alternately stacked with separators interposed therebetween, may be applied. Examples of the battery case 15 include metal cases having a cylindrical shape, a square shape, a coin shape, a button shape, or the like, and resin cases (so-called laminated type) formed by lamination with a resin sheet.

The electrolyte may be an aqueous electrolyte, but is preferably a non-aqueous electrolyte containing a non-aqueous solvent and an electrolyte salt dissolved in the nonaqueous solvent. Examples of the non-aqueous solvent include esters, ethers, nitriles, amides, and mixtures of two or more of them. The non-aqueous solvent may contain a halogen-substituted product in which at least a part of hydrogen in a solvent described above is substituted with a halogen atom such as fluorine. Examples of the electrolyte salt include lithium salts such as LiPF₆. The electrolyte is not limited to a liquid electrolyte, and may be a solid electrolyte in which a gel polymer or the like is used.

The case body 16 is, for example, a bottomed cylindrical metal container. A gasket 28 is provided between the case body 16 and the sealing assembly 17 to ensure the sealability inside the battery. The case body 16 has a projecting portion 22 in which, for example, a part of the side part of the case body 16 protrudes inward to support the sealing assembly 17. The projecting portion 22 is preferably formed in an annular shape along the circumferential direction of the case body 16, and supports the sealing assembly 17 on its upper surface.

The sealing assembly 17 has a structure in which a filter 23, a lower vent member 24, an insulating member 25, an upper vent member 26, and a cap 27 are sequentially stacked from the electrode assembly 14 side. Each member included in the sealing assembly 17 has, for example, a disk shape or a ring shape, and the members excluding the insulating member 25 are electrically connected to each other. The lower vent member 24 and the upper vent member 26 are connected to each other at the respective center regions, and the insulating member 25 is interposed between the respective peripheral portions. When the internal pressure of the secondary battery 10 increases due to heat generated by an internal short circuit or the like, for example, the lower vent member 24 deforms so as to push the upper vent member 26 up toward the cap 27 side and breaks, and thus the current pathway between the lower vent member 24 and the upper vent member 26 is cut off. When the internal pressure further increases, the upper vent member 26 breaks, and gas is discharged from an opening of the cap 27.

In the secondary battery 10 illustrated in FIG. 1, a positive electrode lead 20 attached to the positive electrode 11 extends to the sealing assembly 17 side through a through hole of the insulating plate 18, and a negative electrode lead 21 attached to the negative electrode 12 extends to the bottom side of the case body 16 through the outside of the insulating plate 19. The positive electrode lead 20 is connected to the lower surface of the filter 23, which is the bottom plate of the sealing assembly 17, by welding or the like, and the cap 27, which is electrically connected to the filter 23 and is the top plate of the sealing assembly 17, serves as a positive electrode terminal. The negative electrode lead 21 is connected to the bottom inner surface of the case body 16 by welding or the like, and the case body 16 serves as a negative electrode terminal.

Hereinafter, the positive electrode 11, the negative electrode 12, and the separator 13 will be described in detail.

### [Positive Electrode]

The positive electrode 11 includes a positive electrode current collector and a positive electrode mixture layer arranged on the positive electrode current collector. As the positive electrode current collector, a foil of a metal, such as aluminum, that is stable in a potential range of the positive electrode 11, a film in which the metal is disposed on its surface layer, or the like can be used. The positive electrode mixture layer is preferably provided on both surfaces of the positive electrode current collector. The positive electrode mixture layer contains a positive electrode active material. The positive electrode mixture layer may contain a binder, a conductive agent, or the like. The positive electrode 11 can be produced, for example, by applying a positive electrode mixture slurry containing a positive electrode active material, a binder, a conductive agent, and the like onto a positive electrode current collector, drying a coating film, and then compressing the coating film to form a positive electrode mixture layer on the positive electrode current collector.

Examples of the conductive agent contained in the positive electrode mixture layer include carbon particles such as carbon black, acetylene black, Ketjenblack, and graphite. Examples of the binder contained in the positive electrode mixture layer include fluororesins such as polytetrafluoroethylene (PTFE) and polyvinylidene fluoride (PVdF), polyacrylonitrile (PAN), polyimides, acrylic resins, polyolefins, cellulose derivatives such as carboxymethylcellulose (CMC) and its salts, and polyethylene oxide (PEO).

The positive electrode active material includes a positive electrode active material A and a positive electrode active material B. The positive electrode active material A includes single crystalline particles of a lithium-containing composite oxide and a carbonaceous coating film that covers the surface of each of the single crystalline particles of the lithium-containing composite oxide. The positive electrode active material B includes polycrystalline particles of a lithium-containing composite oxide.

The single crystalline particles of the lithium-containing composite oxide are each composed of a single particle, and no grain boundary of primary particles is confirmed in a particle cross section observed by SEM. On the other hand, the polycrystalline particles of the lithium-containing composite oxide are each composed of secondary particles in which primary particles are aggregated, and grain boundaries of the primary particles are confirmed in a particle cross section observed by SEM.

With respect to the positive electrode active material A, the coating amount of the carbonaceous coating film covering the surfaces of the single crystalline particles of the lithium-containing composite oxide is greater than or equal to 1% by mass and less than or equal to 10% by mass, and preferably greater than or equal to 2% by mass and less than or equal to 10% by mass relative to the mass of the lithium-containing composite oxide of the single crystalline particles. On the other hand, the positive electrode active material B may include a carbonaceous coating film covering the surfaces of the polycrystalline particles of the lithium-containing composite oxide, but, in this case, the coating amount of the carbonaceous coating film needs to be smaller than the coating amount of the carbonaceous coating film covering the surfaces of the single crystalline particles of the lithium-containing composite oxide. At the time of producing the positive electrode 11, the positive electrode 11 is compressed, as described above. This compression is performed for the purpose of, for example, increasing the density of the positive electrode mixture layer to increase the volume energy density, and thus a high pressure is applied to the positive electrode mixture layer at the time of compression. Therefore, cracking may occur in the polycrystalline particles of the lithium-containing composite oxide due to compression at the time of producing the positive electrode. Upon cracking of the polycrystalline particles, the cracked portion forms a new surface, and deterioration proceeds from the new surface. Therefore, performance deterioration of the positive electrode active material is accelerated. As a result, the charge-discharge cycle characteristics of the battery are likely to deteriorate. However, it is considered that, in the present embodiment, for example, the surfaces of the single crystalline particles covered by the carbonaceous coating film are more slippery than the surfaces of the polycrystalline particles due to the compression at the time of producing the positive electrode, and thus that the stress applied to the polycrystalline particles from the single crystalline particles which are less likely to crack is relaxed. As a result, cracking of the polycrystalline particles is suppressed, and thus it is considered that performance deterioration of the positive electrode active material is suppressed, thereby suppressing deterioration of charge-discharge cycle characteristics of the battery.

The thickness of the carbonaceous coating film covering the surfaces of the single crystalline particles of the lithium-containing composite oxide is, for example, preferably greater than or equal to 0.5 nm and less than or equal to 10 nm, more preferably greater than or equal to 0.8 nm and less than or equal to 8 nm, and still more preferably greater than or equal to 1 nm and less than or equal to 5 nm. When the thickness of the carbonaceous coating film is less than the lower limit value, slippage during compression may be reduced. When the thickness of the carbonaceous coating film exceeds the upper limit value, extraction and insertion of lithium ions in the positive electrode active material may be inhibited. The coverage of the carbonaceous coating film on the single crystalline particles is preferably greater than or equal to 80%, more preferably greater than or equal to 90%, and still more preferably greater than or equal to 95%. When the coverage of the carbonaceous coating film is less than the lower limit value, slippage during compression may be reduced. The thickness and coverage of the carbonaceous coating film are measured using a transmission electron microscope (TEM), an energy dispersive X-ray microanalyzer (EDX), or the like.

With respect to the positive electrode active material B, when the coating amount of the carbonaceous coating film covering the surfaces of the polycrystalline particles of the lithium-containing composite oxide increases, the difference in slipperiness between the single crystalline particles and the polycrystalline particles decreases during compression of the positive electrode, so that the effect of relaxing the stress applied to the polycrystalline particles is reduced, and cracking of the polycrystalline particles may occur. Therefore, with respect to the positive electrode active material B, the coating amount of the carbonaceous coating film covering the surfaces of the polycrystalline particles of the lithium-containing composite oxide is smaller than the coating amount of the carbonaceous coating film covering the surfaces of the single crystalline particles of the lithium-containing composite oxide, and is preferably less than or equal to 3% by mass and more preferably less than or equal to 1% by mass relative to the mass of the lithium-containing composite oxide of the polycrystalline particles. Furthermore, in the positive electrode active material B, the surfaces of the polycrystalline particles of the lithium-containing composite oxide are preferably not covered by a carbonaceous coating film. That is, the entire surfaces of the polycrystalline particles are preferably exposed.

The lithium-containing composite oxide of the single crystalline particles and the lithium-containing composite oxide of the polycrystalline particles may have the same composition or different compositions, and are not particularly limited. These lithium-containing composite oxides may contain, for example, Ni, Co, Mn, Al, Zr, B, Mg, Se, Y, Ti, Fe, Cu, Zn, Cr, Pb, Sn, Na, K, Ba, Sr, Ca, W, Mo, Nb, Si, or the like. Among these elements, for example, they preferably contain greater than or equal to 85 mol % of Ni relative to the total molar amount of the metal elements except lithium from the viewpoint of increasing the capacity of the battery, and preferably contain at least either one of Al and Mn from the viewpoint of further suppressing deterioration in charge-discharge cycle characteristics.

An average particle diameter of the single crystalline particles is preferably, for example, in a range of greater than or equal to 2 μm and less than or equal to 20 μm. When the average particle diameter satisfies the above range, the density of the positive electrode mixture layer may be improved as compared with that in the case where the average particle diameter does not satisfy the above range. An average particle diameter of the polycrystalline particles is preferably, for example, in a range of greater than or equal to 5 μm and less than or equal to 20 μm. When the average particle diameter of the polycrystalline particles satisfies the above range, the density of the positive electrode mixture layer may be improved as compared with that in the case where the average particle diameter falls outside the above range. The average particle diameter of the single crystalline particles and the average particle diameter of the polycrystalline particles are volume average particle diameters as measured by a laser diffraction method, and are median diameters at which a volume integrated value is 50% in a particle diameter distribution. The average particle diameter of the single crystalline particles and the average particle diameter of the polycrystalline particles can be measured by the laser diffraction method using, for example, MT 3000 II manufactured by MicrotracBEL Corp.

The polycrystalline particles are preferably composed of, for example, greater than or equal to 10000 and less than or equal to 5000000 primary particles per particle. Due to the polycrystalline particles being composed of greater than or equal to 10000 and less than or equal to 5000000 primary particles per particle, for example, formation of fine polycrystalline particles may be suppressed, and deterioration in charge-discharge cycle characteristics may be further suppressed.

A content ratio of the positive electrode active material A to the positive electrode active material B in the positive electrode mixture layer is preferably, for example, in a range of 2:8 to 8:2 by mass ratio, from the viewpoint of further suppressing deterioration in charge-discharge cycle characteristics. The total amount of the positive electrode active material A and the positive electrode active material B is preferably greater than or equal to 90% by mass, and more preferably greater than or equal to 95% by mass relative to the total amount of the positive electrode mixture layer.

An example of a method for producing a lithium-containing composite oxide will be described.

The lithium-containing composite oxide is obtained, for example, by mixing an Li compound and a metal compound other than Li, and firing the mixture under an oxygen atmosphere. Examples of the Li compound include lithium hydroxide, lithium carbonate, and lithium nitrate. The metal compound other than Li is a metal oxide, a metal hydroxide, or the like of Ni, Co, Al, or the like. The metal compound other than Li may contain one metal element or a plurality of metal elements.

The single crystalline particles and the polycrystalline particles can be prepared, for example, by adjusting a mixing ratio between the Li compound and the metal compound other than Li. When the lithium-containing composite oxide is obtained as single crystalline particles, for example, the mixing ratio of the metal compound other than Li to the Li compound is preferably set in a range of 1.0:1.02 to 1.0:1.2 (metal element other than Li:Li) by molar ratio. When the lithium-containing composite oxide is obtained as polycrystalline particles, for example, the mixing ratio of the metal compound other than Li to the Li compound is preferably set in a range of 1.0:1.025 to 1.0:1.15 (metal element other than Li:Li) by molar ratio. Even if the mixing ratio does not satisfy the above range, the single crystalline particles and the polycrystalline particles can be separately produced, for example, by adjusting firing temperatures as follows.

For example, when the lithium-containing composite oxide is obtained as single crystalline particles, the firing temperature of the raw material mixture is preferably in a range of greater than or equal to 900° C. and less than or equal to 1100° C. A firing temperature at this time is preferably greater than or equal to 20 hours and less than or equal to 150 hours. For example, when the lithium-containing composite oxide is obtained as polycrystalline particles, the firing temperature of the raw material mixture is preferably in a range of greater than or equal to 500° C. and less than or equal to 800° C. The firing temperature at this time is preferably greater than or equal to 10 hours and less than or equal to 150 hours.

Examples of a method for covering the carbonaceous coating film on the surfaces of the single crystalline particles and the polycrystalline particles include a method in which particles such as single crystalline particles and a carbon material such as carbon black, acetylene black, Ketjenblack, furnace black, graphite, or carbon nanotubes are dry-mixed in a planetary mill, and then the obtained sample is fired at a predetermined temperature for a predetermined time in an inert atmosphere. The firing temperature is, for example, greater than or equal to 400° C. and less than or equal to 700° C., and a firing time is, for example, greater than or equal to 30 minutes. Examples of other methods include a method of forming a carbonaceous coating film on particle surfaces by a CVD method using a hydrocarbon gas such as acetylene or methane, and a method of forming a carbonaceous coating film on particle surfaces by mixing coal pitch, petroleum pitch, a phenol resin, or the like with particles such as single crystalline particles and performing a heat treatment. The method for covering the carbonaceous coating film is not limited to these methods.

The density of the positive electrode mixture layer is, for example, preferably greater than or equal to 3.55 g/cc, and more preferably greater than or equal to 3.60 g/cc, from the viewpoint of increasing the volume energy density of the battery.

### [Negative Electrode]

The negative electrode 12 includes a negative electrode current collector and a negative electrode mixture layer provided on a surface of the negative electrode current collector. The negative electrode current collector may be, for example, a foil of a metal, such as copper, that is stable in a potential range of the negative electrode 12, a film in which the metal is disposed on its surface layer. The negative electrode mixture layer is preferably provided on both surfaces of the negative electrode current collector. The negative electrode mixture layer contains, for example, a negative electrode active material and a binder. The negative electrode 12 can be produced, for example, by applying a negative electrode mixture slurry containing a negative electrode active material, a binder, and the like onto a negative electrode current collector, drying a coating film, and then compressing the coating film to form a negative electrode mixture layer on the negative electrode current collector.

The negative electrode active material is not particularly limited as long as it is a material capable of reversibly storing and releasing lithium ions, but preferably includes a carbon-based active material. Suitable carbon-based active materials are graphite including natural graphite such as scale-like graphite, massive graphite, and earthy graphite, and artificial graphite such as massive artificial graphite (MAG) and graphitized mesophase carbon microbeads (MCMB). The negative electrode active material may contain a Si-based active material composed of at least one of Si and an Si-containing compound.

As the binder, for example, a fluororesin, PAN, a polyimide, an acrylic resin, a polyolefin, or the like can be used as in the case of the positive electrode 11, and examples thereof include styrene-butadiene rubber (SBR), CMC and a salt thereof, polyacrylic acid (PAA) and a salt thereof, and polyvinyl alcohol (PVA).

### [Separator]

As the separator 13, for example, a porous sheet having an ion permeation property and an insulation property is used. Specific examples of the porous sheet include fine porous thin films, woven fabrics, and nonwoven fabrics. As a material for the separator 13, polyolefins such as polyethylene and polypropylene, cellulose, and the like are suitable. The separator 13 may have either a single layer structure or a laminated structure. A heat resistant layer or the like may be formed on a surface of the separator 13.

### EXAMPLES

Hereinafter, the present disclosure will be further described with reference to Examples. However, the present disclosure is not limited to these Examples.

### EXAMPLE

### [Production of Lithium-Containing Composite Oxide of Single Crystalline Particle]

Nickel sulfate, cobalt sulfate, and manganese sulfate were mixed at a predetermined ratio, and uniformly mixed in an alkaline aqueous solution having a pH of 10 to 11 to obtain a precursor. The precursor and lithium carbonate were mixed and fired at 1000° C. for 15 hours in an oxygen atmosphere, and the obtained fired product was pulverized to obtain a lithium-containing composite oxide of single crystalline particles. As a result of analysis by ICP, the composition of this lithium-containing composite oxide was LiNi_{0.5}Co_{0.2}Mn_{0.3}O₂.

### [Covering of Carbonaceous Coating Film on Surface of Single Crystalline Particle]

The lithium-containing composite oxide of the single crystalline particles and acetylene black were weighed at a mass ratio of 95:5, and subjected to a dry stirring treatment at 200 rpm for 24 hours in a planetary mill. The obtained sample was heat-treated at 550° C. for 1 hour in an argon atmosphere to obtain a positive electrode active material A in which the carbonaceous coating film of acetylene black was covered on the surfaces of the single crystalline particles of the lithium-containing composite oxide.

### [Production of Lithium-Containing Composite Oxide of Polycrystalline Particle]

The nickel-cobalt-aluminum composite hydroxide represented by Ni_{0.91}Co_{0.06}Al_{0.03}(OH)₂ obtained by coprecipitation was fired at 500° C. to obtain a nickel-cobalt-aluminum composite oxide. Next, lithium hydroxide and the obtained nickel-cobalt-aluminum composite oxide were mixed so that the molar ratio of Li to the total amount of Ni, Co, and Mn was 1.05:1. This mixture was fired at 750° C. for 3 hours in an oxygen atmosphere and then pulverized to obtain a lithium-containing composite oxide of polycrystalline particles (the average particle diameter of the secondary particles was 10 μm). As a result of analysis by ICP, the composition of this lithium-containing composite oxide was Li_{1.05}Ni_{0.91}Co_{0.06}Al_{0.03}O₂. The polycrystalline particles of the lithium-containing composite oxide were used as a positive electrode active material B.

### [Production of Positive Electrode]

A positive electrode mixture slurry was prepared by mixing 50 parts by mass of the positive electrode active material A, 50 parts by mass of the positive electrode active material B, 0.8 parts by mass of carbon black, and 0.7 parts by mass of polyvinylidene fluoride, and adding an appropriate amount of N-methyl-2-pyrrolidone (NMP) to this mixture. The positive electrode mixture slurry was applied onto both surfaces of a positive electrode current collector made of an aluminum foil having a thickness of 15 μm, and a coating film was dried. The amounts of the positive electrode mixture slurries applied onto both surfaces was 560 g/m² in total. The obtained positive electrode was compressed using a roller until the positive electrode thickness reached 171 μm and the positive electrode density reached 3.59 g/cc, and cut into a predetermined electrode size. This product was used as a positive electrode of the Example.

### [Production of Negative Electrode]

A negative electrode mixture slurry was prepared by mixing 95 parts by mass of graphite particles, 5 parts by mass of Si oxide, 1 part by mass of carboxymethyl cellulose (CMC), 1 part by mass of styrene-butadiene rubber (SBR), and water. The negative electrode mixture slurry was applied onto both surfaces of a negative electrode current collector made of a copper foil having a thickness of 10 μm, and a coating film was dried. The amounts of the negative electrode mixture slurries applied onto both surfaces was 282 g/m² in total. The obtained negative electrode was compressed using a roller until the negative electrode thickness reached 138 μm, and cut into a predetermined electrode size.

### [Preparation of Non-Aqueous Electrolyte]

To a mixed solvent obtained by mixing ethylene carbonate (EC), dimethyl carbonate (DMC), and ethyl methyl carbonate (EMC) at a volume ratio of 20:60:20, 2% by mass of vinylene carbonate (VC) was added. Lithium hexafluorophosphate (LiPF₆) was dissolved in this solvent at a concentration of 1.3 mol/liter to prepare a non-aqueous electrolyte.

### [Production of Negative Electrode]

An aluminum lead was attached to the positive electrode and a nickel lead was attached to the negative electrode. The positive electrode and the negative electrode were spirally wound with a separator made of polyolefin interposed therebetween. Then, the positive electrode and the negative electrode were press-molded in the radial direction to prepare a flat wound electrode assembly. The electrode assembly was housed in an exterior body composed of an aluminum laminate sheet, and the non-aqueous electrolyte was injected thereinto. Then, an opening of the exterior body was sealed to obtain a non-aqueous electrolyte secondary battery.

### Comparative Example 1

A non-aqueous electrolyte secondary battery was produced in the same manner as in the Example, except that the single crystalline particles of the lithium-containing composite oxide of Example 1 not covered by the carbonaceous coating film were used as the positive electrode active material A, and that the active material obtained by covering the polycrystalline particles of the lithium-containing composite oxide of Example 1 by the carbonaceous coating film were used as the positive electrode active material B. A specific method for producing the positive electrode active material B is as follows. The lithium-containing composite oxide of the polycrystalline particles of Example 1 and acetylene black were weighed at a mass ratio of 95:5, and subjected to a dry stirring treatment at 200 rpm for 24 hours in a planetary mill. The obtained carbon composite sample was heat-treated at 550° C. for 1 hour in an argon atmosphere to obtain a positive electrode active material B in which the surfaces of the polycrystalline particles of the lithium-containing composite oxide was covered by the carbonaceous coating film of acetylene black.

### Comparative Example 2

A non-aqueous electrolyte secondary battery was produced in the same manner as in the Example, except that the single crystalline particles of the lithium-containing composite oxide of Example 1 not covered by the carbonaceous coating film were used as the positive electrode active material A.

### Comparative Example 3

A non-aqueous electrolyte secondary battery was produced in the same manner as in the Example, except that the positive electrode active material B of Comparative Example 3 was used as the positive electrode active material B.

### Comparative Example 4

A non-aqueous electrolyte secondary battery was produced in the same manner as in the Example, except that only the positive electrode active material B of Comparative Example 3 was used as the positive electrode active material.

### Comparative Example 5

An attempt was made to produce a positive electrode in the same manner as in the Example except that only the positive electrode active material A of Example 1 was used as the positive electrode active material, but the positive electrode could not be compressed until the positive electrode density reached 3.59 g/cc. Therefore, in Comparative Example 5, the following charge-discharge cycle test was not performed.

### [Charge-Discharge Cycle Test]

The non-aqueous electrolyte secondary batteries of the Example and Comparative Examples 1 to 4 were subjected to charge at a constant current of 0.5 C under a temperature environment of 25° C. until the battery voltage reached 4.2 V, and subjected to constant voltage charge at a voltage of 4.2 V until the current value reached 1/50 C.

Then, the batteries were subjected to constant current discharge at a constant current of 0.5 C until the battery voltage reached 2.5 V. This charge-discharge cycle was repeated 300 times. Then, the capacity retention rate in the charge-discharge cycles was determined by the following equation.

$$Capacity retention rate ( \% ) = ( discharge capacity at {300}^{th} cycle / discharge capacity at {1}^{st} cycle ) \times 100$$

TABLE 1

| | Coating amount of | | |
|---|---|---|---|
| | carbonaceous coating film | | |
| | Single | Poly- | Capacity |
| | crystalline | crystalline | retention |
| | particle | particle | rate |
| Example | 5.3 wt % | 0 wt % | 85% |
| Comparative | 0 wt % | 5.3 wt % | 76% |
| Example 1 | | | |
| Comparative | 0 wt % | 0 wt % | 75% |
| Example 2 | | | |
| Comparative | 5.3 wt % | 5.3 wt % | 80% |
| Example 3 | | | |
| Comparative | — | 5.3 wt % | 70% |
| Example 4 | | | |
| Comparative | 5.3 wt % | — | — |
| Example 5 | | | |

As shown in Table 1, in the Example, the capacity retention rate after the charge-discharge cycle test was higher than that in Comparative Examples 1 to 4. Hence, according to the Example, the positive electrode for secondary batteries and the secondary battery are capable of suppressing deterioration in charge-discharge cycle characteristics of the secondary battery even when a positive electrode active material containing single crystalline particles and polycrystalline particles is used.

### REFERENCE SIGNS LIST

10 Secondary battery
11 Positive electrode
12 Negative electrode
13 Separator
14 Electrode assembly
15 Battery case
16 Case body
17 Sealing assembly
18, 19 Insulating plate
20 Positive electrode lead
21 Negative electrode lead
22 Projecting portion
23 Filter
24 Lower vent member
25 Insulating member
26 Upper vent member
27 Cap
28 Gasket

1. A positive electrode for secondary batteries, comprising: a positive electrode current collector; and a positive electrode mixture layer that is arranged on the positive electrode current collector, wherein
the positive electrode mixture layer comprises: a positive electrode active material A which is composed of single crystalline particles of a lithium-containing composite oxide; and a positive electrode active material B which is composed of polycrystalline particles of a lithium-containing composite oxide,
the positive electrode active material A has a carbonaceous coating film that covers a surface of each of the single crystalline particles, a coating amount of the carbonaceous coating film covering surfaces of the single crystalline particles is greater than or equal to 1% by mass and less than or equal to 10% by mass relative to a mass of the lithium-containing composite oxide of the single crystalline particles, and
with respect to the positive electrode active material B, when surfaces of the polycrystalline particles are covered by a carbonaceous coating film, the coating amount of the carbonaceous coating film covering the surfaces of the polycrystalline particles is smaller than the coating amount of the carbonaceous coating film covering the surfaces of the single crystal particles.

2. The positive electrode for secondary batteries according to claim 1, wherein with respect to the positive electrode active material B, when the surfaces of the polycrystalline particles are covered by a carbonaceous coating film, the coating amount of the carbonaceous coating film covering the surfaces of the polycrystalline particles is less than or equal to 3% by mass relative to the mass of the lithium-containing composite oxide of the polycrystalline particles.

3. The positive electrode for secondary batteries according to claim 1, wherein, with respect to the positive electrode active material B, the surfaces of the polycrystalline particles are not covered by a carbonaceous coating film.

4. The positive electrode for secondary batteries according to claim 1, wherein a content ratio of the positive electrode active material A to the positive electrode active material B is in a range of 2:8 to 8:2 by mass ratio.

5. A secondary battery comprising the positive electrode for secondary batteries according to claim 1.
